(19) United States
(12) Patent Application Publication
(10) Pub. No.: US 2018/0046278 A1
(43) Pub. Date: Feb. 15, 2018

(54) TOUCH DISPLAY PANEL

(71) Applicant: HON HAI PRECISION INDUSTRY CO., LTD., New Taipei (TW)

(72) Inventors: YU-FU WENG, New Taipei (TW); CHIEN-WEN LIN, New Taipei (TW); CHIA-LIN LIU, New Taipei (TW)

(21) Appl. No.: 15/660,960

(22) Filed: Jul. 27, 2017

Related U.S. Application Data
(60) Provisional application No. 62/374,095, filed on Aug. 12, 2016.

(51) Int. Cl. G06F 3/044; G02F 1/1343; G02F 1/1335; G06F 3/041; G02F 1/1333; G02F 1/1368

(52) U.S. Cl. CPC G06F 3/044; G02F 1/13338; G02F 1/1368; G02F 1/133514; G06F 3/0412; G02F 1/134309; G06F 2203/04105

(57) ABSTRACT

A touch display panel includes a color filter substrate, a thin film transistor substrate, a liquid crystal layer between the color filter substrate and the thin film transistor substrate, a touch sensing structure, and a force sensing structure. The touch display panel defines a display area and a border area surrounding the display area. The touch sensing structure is in the display area, and the force sensing structure is in the border area. The force sensing structure includes a plurality of first force sensing electrodes and a second force sensing electrode stacked on and electrically insulated from the first force sensing electrodes. The first force sensing electrodes and the second force sensing electrode cooperatively form a capacitive force sensing structure.

### FIELD

The subject matter herein generally relates to a touch display panel.

### BACKGROUND

An on-cell or in-cell type touch screen panel can be manufactured by installing a touch panel in a display panel. Such a touch screen panel is used as an output device for displaying images while being used as an input device for receiving a command of a user touching a specific area of a displayed image. However, the touch screen panel cannot sense the pressure of the touch.

### BRIEF DESCRIPTION OF THE DRAWINGS

Implementations of the present disclosure will now be described, by way of example only, with reference to the attached figures.

FIG. 1 is an isometric view of an exemplary embodiment of a touch display panel.

FIG. 2 is an exploded view of a first exemplary embodiment of a touch display panel.

FIG. 3 is a cross-sectional view of the first exemplary embodiment of the touch display panel of FIG. 1 along line III-III.

FIG. 4 is an exploded view of a second exemplary embodiment of a touch display panel.

FIG. 5 is a cross-sectional view of the second exemplary embodiment of the touch display panel of FIG. 4.

FIG. 6 is an exploded view of a third exemplary embodiment of a touch display panel.

FIG. 7 is a cross-sectional view of the third exemplary embodiment of the touch display panel of FIG. 6.

### DETAILED DESCRIPTION

It will be appreciated that for simplicity and clarity of illustration, where appropriate, reference numerals have been repeated among the different figures to indicate corresponding or analogous structures. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

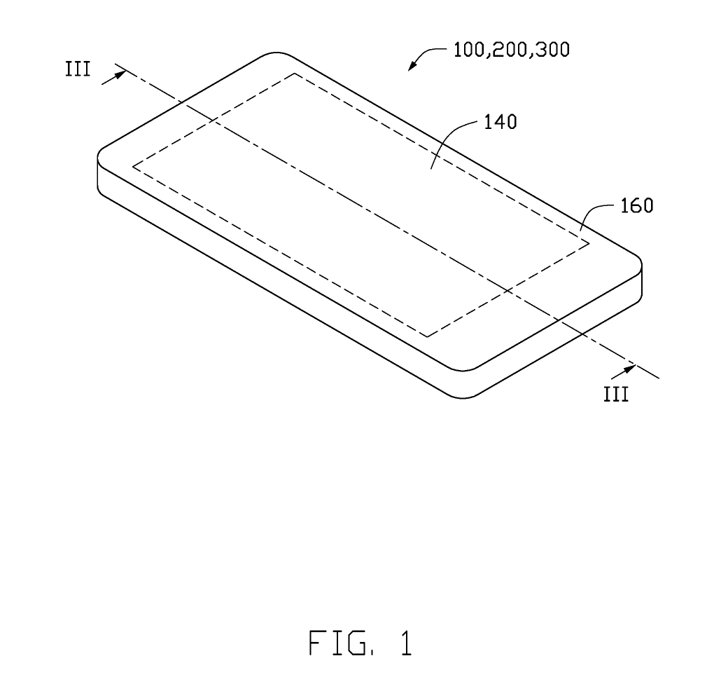

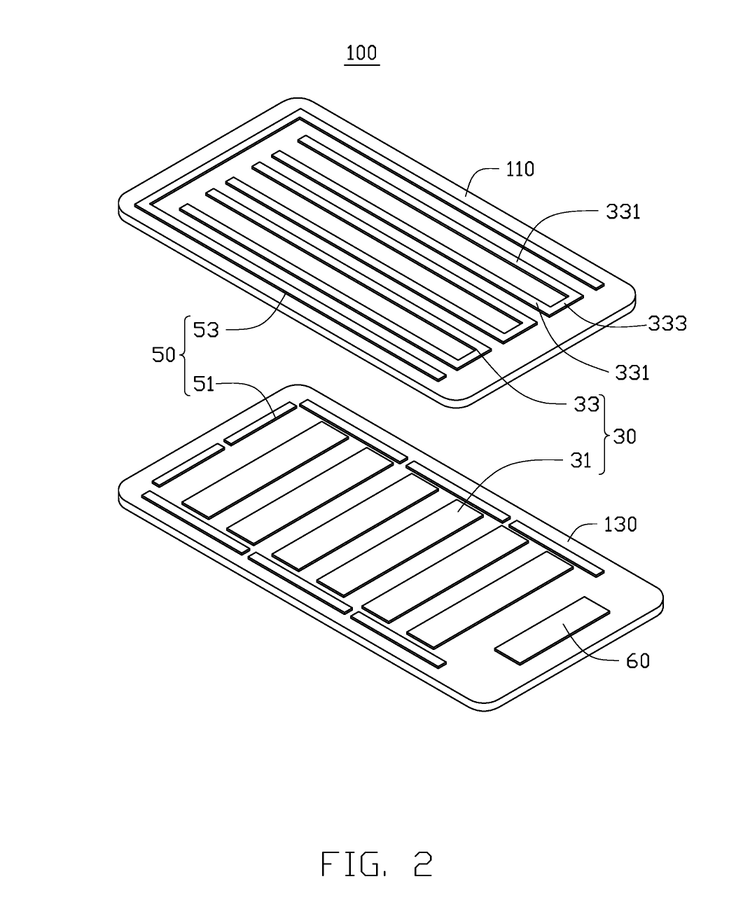

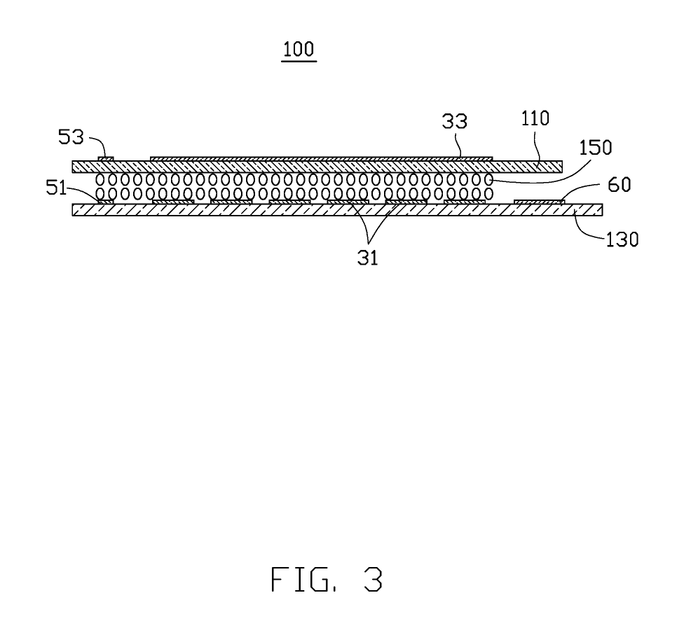

FIG. 1, FIG. 2, and FIG. 3 illustrate a touch display panel 100 according to a first exemplary embodiment.

In the present exemplary embodiment, the touch display panel 100 is an in-cell touch liquid crystal display panel. FIG. 2 does not show a liquid crystal layer of the touch display panel 100. The touch display panel 100 includes a color filter substrate 110, a thin film transistor substrate 130 facing the color filter substrate 110, and a liquid crystal layer 150 between the color filter substrate 110 and the thin film transistor substrate 130. The thin film transistor substrate 130 is a conventional thin film transistor substrate and includes a substrate (not shown) and a plurality of thin film transistors (not shown) on the substrate. The color filter substrate 110 is a conventional color filter substrate comprising a substrate (not shown) and a color filter layer (not shown) on the substrate. The touch display panel 100 defines a display area 140 and a border area 160 surrounding the display area 140.

The touch display panel 100 further includes a touch sensing structure 30 configured for sensing touch positions and a force sensing structure 50 configured for sensing force of touch. Both the touch sensing structure 30 and the force sensing structure 50 are formed on the color filter substrate 110 and the thin film transistor substrate 130. The touch sensing structure 30 is positioned in the display area 140, and the force sensing structure 50 is positioned in the border area 160.

As shown in FIG. 2 and FIG. 3, the touch sensing structure 30 includes a plurality of first touch electrodes 31 and a plurality of second touch electrodes 33. The plurality of first touch electrodes 31 is formed on a surface of the thin film transistor substrate 130 facing the color filter substrate 110. The plurality of second touch electrodes 33 is formed on a surface of the color filter substrate 110 away from the thin film transistor substrate 130. As shown in FIG. 2, the plurality of first touch electrodes 31 are spaced apart from each other; and each first touch electrode 31 has a strip shape and extends along a first direction. The plurality of second touch electrodes 33 are spaced apart from each other, and each second touch electrode 33 is substantially U-shaped. Each second touch electrode 33 includes two extending portions 331 parallel to each other and a connecting portion 333 between the two extending portions 331. Each extending portion 331 extends along a second direction. The second direction is different from the first direction. In the present exemplary embodiment, the first direction is substantially perpendicular to the second direction. The first touch electrodes 31 are used as touch driving electrode for transmitting driving signal, and the second touch electrodes 33 are used to receive touch sensing signals. In the present exemplary embodiment, the first touch electrodes 31 also function as common electrodes of the touch display panel 100 and cooperate with pixel electrodes (not shown) to drive the liquid crystals in the liquid crystal layer 150 to rotate.

As shown in FIG. 2 and FIG. 3, the force sensing structure 50 includes a plurality of first force sensing electrodes 51 and a second force sensing electrode 53. The first force sensing electrodes 51 and the first touch electrodes 31 are formed on a same surface. The first force sensing electrodes 51 are formed on the surface of the thin film transistor substrate 130 facing the color filter substrate 110. The first force sensing electrodes 51 cooperate to surround the first touch electrodes 31. The first touch electrodes 31 and the first force sensing electrodes 51 may be defined by a same conductive material layer and be formed by a single patterning process. The first touch electrodes 31 and the first force sensing electrode 51 may be made of a same transparent conductive material, such as indium tin oxide.

As shown in FIG. 2 and FIG. 3, the second force sensing electrode 53 and the second touch electrodes 33 are formed on the same surface. The second force sensing electrode 53 is formed on the surface of the color filter substrate 110 away from the thin film transistor substrate 130 and surrounds the second touch electrodes 33. The second force sensing electrode 53 and the second touch electrodes 33 may be defined by a same conductive material layer and be formed by a single patterning process. The second force sensing electrode 53 and the second touch electrodes 33 may be made of a transparent conductive material, such as indium tin oxide.

A projection of the first force sensing electrodes 51 on the color filter substrate 110 overlaps with the second force sensing electrode 53.

The first force sensing electrodes 51 are spaced apart from each other. The first force sensing electrodes 51 cooperate to surround the first touch electrodes 31 and are located in the border area 160. The second force sensing electrode 53 is continuous and extends to surround the second touch electrodes 33. In the present exemplary embodiment, the second force sensing electrode 53 is substantially U-shaped. In other embodiments, the second force sensing electrode 53 may have a rectangle shape.

In the present exemplary embodiment, each first force sensing electrode 51 has a strip shape and a length of more than 4 mm and a width of more than 100 μm. It is understood that the length of each first force sensing electrode 51 may be adjusted according to a number of the first force sensing electrodes 51. It is understood that the shape of each first force sensing electrode 51 may be adjusted, not being limited to a strip shape.

The touch display panel 100 further includes a touch control circuit 60 in the border area 160, particularly on the thin film transistor substrate 130. The touch sensing structure 30 is electrically coupled to the touch control circuit 60 by a plurality of traces (not shown). For example, each first touch electrode 31 may be electrically coupled to the touch control circuit 60 by one trace and each second touch electrode 33 may be electrically coupled to the touch control circuit 60 by one trace. When a finger is touching the display panel 100, electric signals of the second touch electrodes 33 corresponding to the touch position will vary. The variation of the electric signal is transmitted to the touch control circuit 60 by the traces, thus the touch position can be detected.

In the present exemplary embodiment, the second force sensing electrode 53 is grounded. The first force sensing electrodes 51 and the second force sensing electrode 53 cooperatively form a capacitive force sensing structure. When a finger is touching the display panel 100, a distance between the second force sensing electrode 53 and the first force sensing electrodes 51 corresponding to the touch position may change, thus a capacitance value between the second force sensing electrode 53 and the first force sensing electrodes 51 will vary. The touch force can be calculated by the variation of the capacitance value.

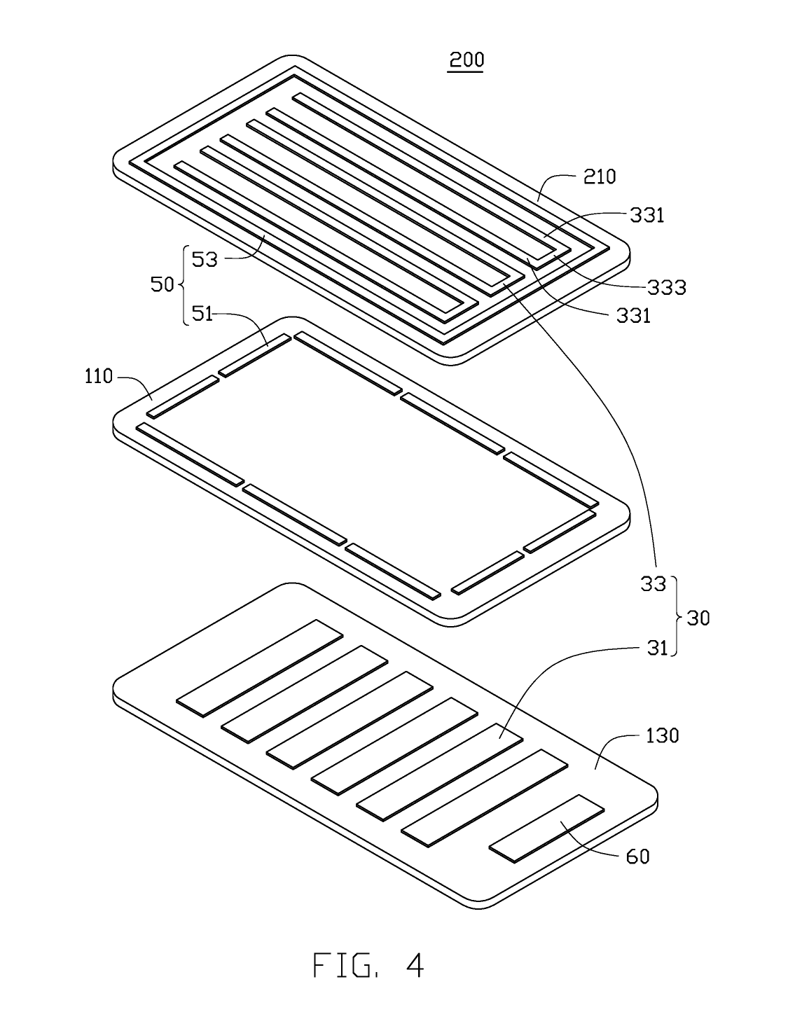

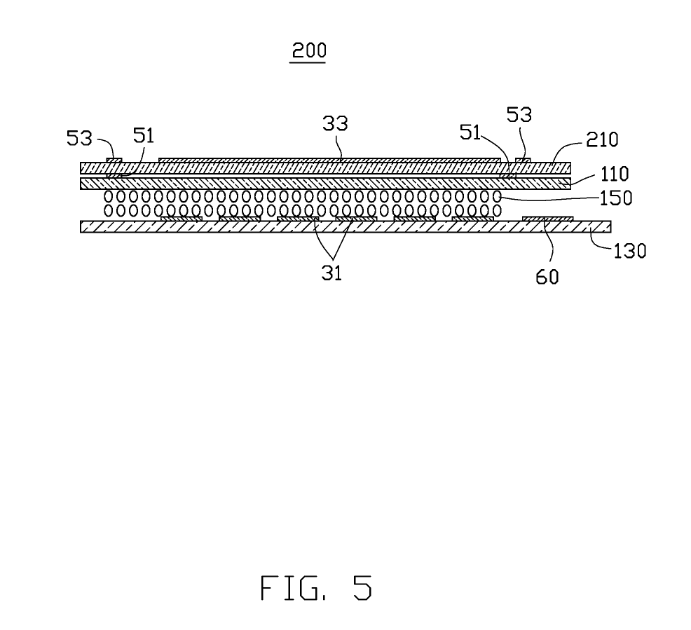

FIG. 1, FIG. 4, and FIG. 5 illustrate a touch display panel 200 according to a second exemplary embodiment.

In the second exemplary embodiment, the touch display panel 200 is an in-cell touch liquid crystal display panel. FIG. 5 does not show a liquid crystal layer of the touch display panel 200. The touch display panel 200 includes a color filter substrate 110, a thin film transistor substrate 130 facing color filter substrate 110, a liquid crystal layer 150 between the color filter substrate 110 and the thin film transistor substrate 130, and a dielectric layer 210 stacked at a side of the color filter substrate 110 away from the thin film transistor substrate 130. The thin film transistor substrate 130 is a conventional thin film transistor substrate and includes a substrate (not shown) and a plurality of thin film transistors (not shown) on the substrate. The color filter substrate 110 is a conventional color filter substrate comprising a substrate (not shown) and a color filter layer (not shown) on the substrate. The touch display panel 200 defines a display area 140 and a border area 160 surrounding the display area 140. The dielectric layer 210 is elastic and transparent.

The touch display panel 200 further includes a touch sensing structure 30 configured for sensing touch position and a force sensing structure 50 configured for sensing force. The touch sensing structure 30 is in the display area 140, and the force sensing structure 50 is in the border area 160.

As shown in FIG. 4 and FIG. 5, the touch sensing structure 30 includes a plurality of first touch electrodes 31 and a plurality of second touch electrodes 33. The plurality of first touch electrodes 31 is formed on a surface of the thin film transistor substrate 130 facing the color filter substrate 110. The plurality of second touch electrodes 33 is formed on a surface of the dielectric layer 210 away from the thin film transistor substrate 130. As shown in FIG. 4, each of the plurality of first touch electrodes 31 are spaced apart from each other; and each first touch electrode 31 has a strip shape and extends along a first direction. The plurality of second touch electrodes 33 are spaced apart from each other, and each second touch electrode 33 is substantially U-shaped. Each second touch electrode 33 includes two parallel extending portions 331 and a connecting portion 333 between the two extending portions 331. Each extending portion 331 extends along a second direction. The second direction is different from the first direction. In the present exemplary embodiment, the first direction is substantially perpendicular to the second direction. The first touch electrodes 31 are used as touch driving electrode for transmitting driving signals, and the second touch electrodes 33 are used to receive touch sensing signals. In the present exemplary embodiment, the first touch electrodes 31 also function as common electrodes of the display panel 100 and cooperate with pixel electrodes (not shown) to drive the liquid crystals in the liquid crystal layer 150 to rotate.

As shown in FIG. 4 and FIG. 5, the force sensing structure 50 includes a plurality of first force sensing electrodes 51 and a second force sensing electrode 53. The first force sensing electrodes 51 are formed on a surface of the color filter substrate 110 away from the thin film transistor substrate 130. The first force sensing electrodes 51 cover a periphery of the color filter substrate 110.

As shown in FIG. 4 and FIG. 5, the second force sensing electrode 53 and the second touch electrodes 33 are formed on the same surface. The second force sensing electrode 53 is formed on the surface of the dielectric layer 210 away from the thin film transistor substrate 130 and surrounds the second touch electrodes 33. The second force sensing electrode 53 and the second touch electrodes 33 may be defined by a same conductive material layer and be formed by a single patterning process. The second force sensing electrode 53 and the second touch electrodes 33 may be made of transparent conductive material, such as indium tin oxide.

A projection of the first force sensing electrodes 51 on the dielectric layer 210 overlaps with the second force sensing electrode 53.

The first force sensing electrodes 51 are spaced apart from each other and located in the border area 160. The second force sensing electrode 53 is continuous and extends to surround the second touch electrodes 33. In the present exemplary embodiment, the second force sensing electrode 53 is rectangle shape. In the present exemplary embodiment, each first force sensing electrode 51 has a strip shape, a length of more than 4 mm and a width of more than 100 μm. It is understood that the length of each first force sensing electrode 51 may be adjusted according to a number of the first force sensing electrodes 51. It is understood that the shape of each first force sensing electrode 51 may be adjusted, not being limited to a strip shape.

The display panel 200 further includes a touch control circuit 60 in the border area 160 and on the thin film transistor substrate 130. The touch sensing structure 30 is electrically coupled to the touch control circuit 60 by a plurality of traces (not shown). For example, each first touch electrode 31 may be electrically coupled to the touch control circuit 60 by one trace and each second touch electrode 33 may be electrically coupled to the touch control circuit 60 by one trace. When a finger is touching the display panel 200, the electric signals of the second touch electrodes 33 corresponding to the touch position will vary, and the variation of the electric signals is transmitted to the touch control circuit 60 by traces, thus the touch position can be detected.

In the present exemplary embodiment, the second force sensing electrode 53 is grounded. The first force sensing electrodes 51 and the second force sensing electrode 53 cooperatively form a capacitive force sensing structure. When a finger is touching the display panel 200, a distance between the second force sensing electrode 53 and the first force sensing electrodes 51 corresponding to the touch position may change, thus the capacitance value between the second force sensing electrode 53 and the first force sensing electrodes 51 will vary. Thus touch force can be calculated by the variation of the capacitance value.

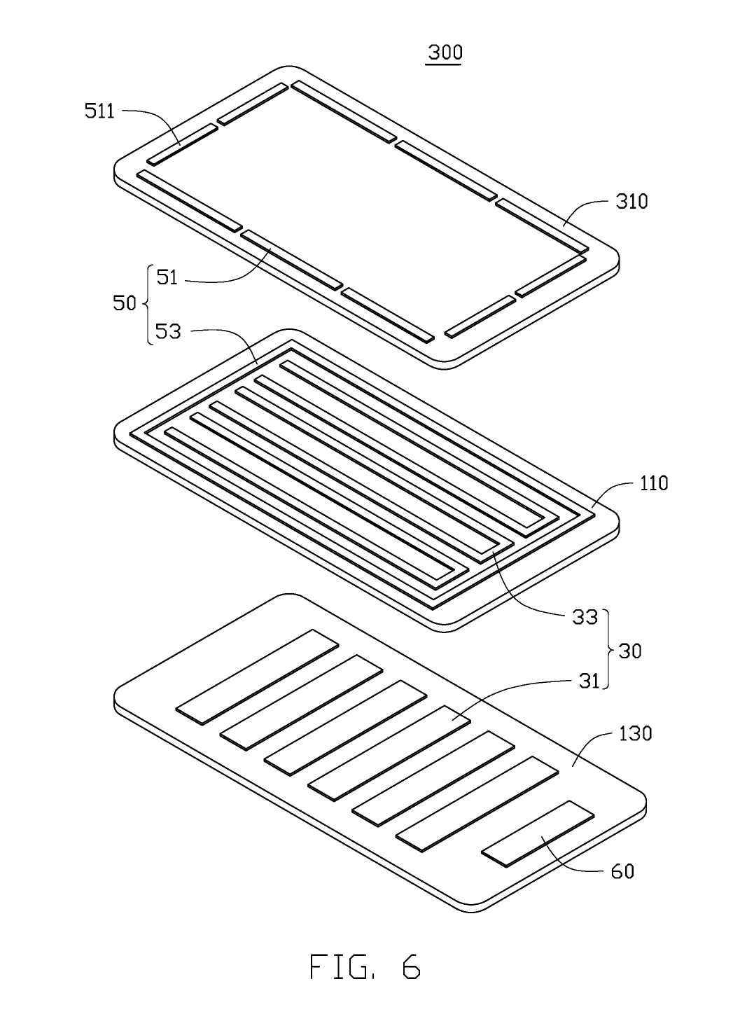

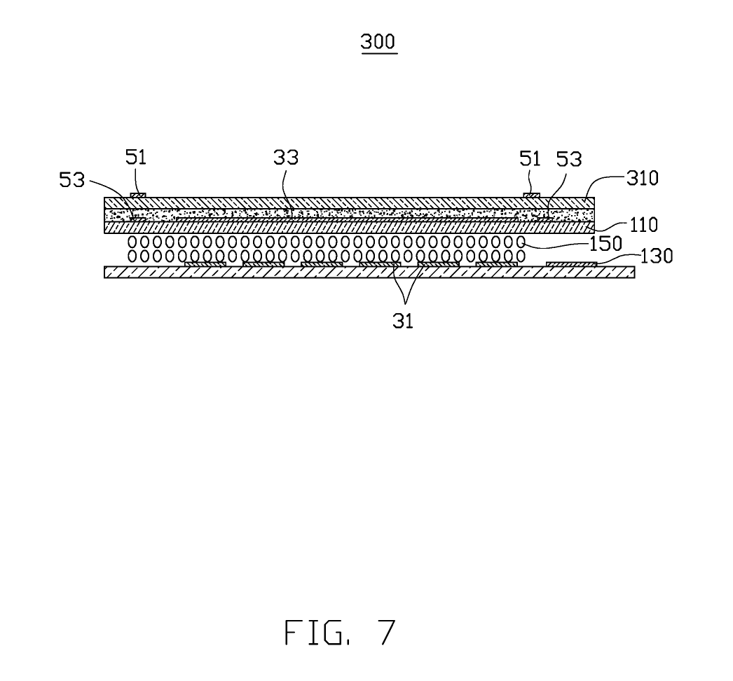

FIG. 1, FIG. 6, and FIG. 7 illustrate a touch display panel 300 according to a third exemplary embodiment.

In the present exemplary embodiment, the touch display panel 300 is an in-cell touch liquid crystal display panel. FIG. 6 does not show a liquid crystal layer of the touch display panel 300. The touch display panel 300 is substantially the same as the display panel 100 of the first exemplary embodiment, except that the touch display panel 300 further includes a cover plate 310 stacked at a side of the color filter substrate 110 away from the thin film transistor substrate 130. Another difference is that the first force sensing electrodes 51 are formed on a surface of the cover plate 310. In this exemplary embodiment the first force sensing electrodes 51 are formed on a surface of the cover plate 310 away from the thin film transistor substrate 130. In other embodiments, the first force sensing electrodes 51 may be formed on a surface of the cover plate 310 adjacent to the thin film transistor substrate 130. The cover plate 310 is transparent.

The first force sensing electrodes 51 cover a periphery of the cover plate 310. The cover plate 310 is bonded to the color filter substrate 110 by an optical clear adhesive 80.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A touch display panel comprising:
a color filter substrate;
a thin film transistor substrate facing the color filter substrate;
a liquid crystal layer between the color filter substrate and the thin film transistor substrate;
a touch sensing structure; and
a force sensing structure;
the touch display panel defining a display area and a border area surrounding the display area, the touch sensing structure being in the display area, the force sensing structure being in the border area;
wherein the force sensing structure comprises a plurality of first force sensing electrodes and a second force sensing electrode stacked on and electrically insulated from the plurality of first force sensing electrodes; the plurality of first force sensing electrodes and the second force sensing electrode cooperatively form a capacitive force sensing structure.

2. The touch display panel of claim 1, wherein the touch sensing structure comprises a plurality of first touch sensing electrodes and a plurality of second touch sensing electrodes stacked on and electrically insulated from the plurality of first touch sensing electrodes; each of the plurality of first touch sensing electrodes extends along a direction that is different from an extending direction of each of the plurality of second touch sensing electrodes.

3. The touch display panel of claim 2, wherein the plurality of first touch sensing electrodes are formed on a surface of the thin film transistor substrate facing the color filter substrate; and the plurality of second touch sensing electrodes are formed on a surface of the color filter substrate away from the thin film transistor substrate.

4. The touch display panel of claim 3, wherein the plurality of first force sensing electrodes are formed on the surface of the thin film transistor substrate facing the color filter substrate and cooperate to surround the plurality of first touch sensing electrodes; the second force sensing electrode is formed on the surface of the color filter substrate away from the thin film transistor substrate and surrounds the plurality of second touch sensing electrodes.

5. The touch display panel of claim 3, further comprising a cover plate stacked at a side of the color filter substrate away from the thin film transistor substrate; wherein the plurality of first force sensing electrodes are formed on the cover plate; and the second force sensing electrode is formed on the surface of the color filter substrate away from the thin film transistor substrate and surrounds the plurality of second touch sensing electrodes.

6. The touch display panel of claim 2, further comprising a dielectric layer stacked at a side of the color filter substrate away from the thin film transistor substrate, wherein the plurality of first touch sensing electrodes are formed on a surface of the thin film transistor substrate facing the color filter substrate; and the plurality of second touch sensing electrodes are formed on a surface of the dielectric layer away from the thin film transistor substrate.

7. The touch display panel of claim 6, wherein the plurality of first force sensing electrodes are formed on a surface of the color filter substrate away from the thin film transistor substrate; and the second force sensing electrode is formed on the surface of the dielectric layer away from the thin film transistor substrate and surrounds the plurality of second touch sensing electrodes.

8. The touch display panel of claim 6, wherein the dielectric layer is elastic and transparent.

9. The touch display panel of claim 2, wherein the plurality of first touch electrodes are functioned as common electrodes of the touch display panel.

10. The touch display panel of claim 1, wherein the second force sensing electrode is grounded.

11. The touch display panel of claim 2, wherein the plurality of first force sensing electrodes are spaced apart from each other and cooperate to surround the plurality of first touch electrodes.

12. The touch display panel of claim 2, wherein the second force sensing electrode is continuous and extends to surround the plurality of second touch electrodes.

13. The touch display panel of claim 12, wherein the second force sensing electrode is substantially U-shaped or a rectangle.

14. The touch display panel of claim 1, wherein a projection of the plurality of first force sensing electrodes overlap with the second force sensing electrode.

15. The touch display panel of claim 1, wherein the plurality of first touch electrodes are spaced apart from each other; each of the plurality of first touch electrodes has a strip shape and extends along a first direction; the plurality of second touch electrodes is spaced apart from each other, and each of the plurality of second touch electrodes is substantially U-shaped; each of the plurality of second touch electrodes comprises two extending portions parallel to each other and a connecting portion connected to and between the two extending portion; and each of the two extending portions extends along a second direction; the second direction is different from the first direction.
